(19) United States
(12) Patent Application Publication
(10) Pub. No.: US 2011/0062044 A1
(43) Pub. Date: Mar. 17, 2011

(54) BEVERAGE CONTAINER SPACING DEVICE AND METHOD

(75) Inventors: EMAD ABOUL-HOSN, Olathe, KS (US); Christopher W. Graham, Kansas City, MO (US)

(73) Assignee: High Spirits, LLC, Kansas City, MO (US)

(21) Appl. No.: 12/835,738

(22) Filed: Jul. 14, 2010

Related U.S. Application Data
(60) Provisional application No. 61/242,305, filed on Sep. 14, 2009.

(51) Int. Cl. B65D 21/02; B23P 19/04

(52) U.S. Cl. 206/516; 29/700

(57) ABSTRACT

The device fits over the outer surface of a beverage container at a first surface, and a structural member extends between the first surface and a second surface which contacts a second container stacked on the first. The structural member serves to support the separation between the inner surface of the second container and the outer surface of the first container. The related process involves the stacking of beverage containers one upon another employing one device between two containers to create stacks of containers.

### CROSS-REFERENCE TO RELATED APPLICATION

This application claims the benefit of U.S. Provisional Application No. 61/242,305 filed on Sep. 14, 2009.

### FIELD OF THE INVENTION

Present disclosure relates to a method and apparatus for storing beverage containers. More specifically, it discloses a device which aids in spacing stacked beverage containers.

### BACKGROUND OF THE INVENTION

In bar establishments as well as within households and other locations having a number of similarly-shaped beverage containers, it is common for the handlers of such containers to have difficulty efficiently storing them in a manner which allows them to be easily separated from each other at a later time. Traditional stacking, while allowing for the efficient usage of space, will often lead to containers “sticking” to each other, and can lead not only to more difficult separation of containers but also to glass breakage and handler injury, not including the downtime or lost time due to the cleaning, washing and restacking. Where storage occurs simultaneously with cooling or heating, containers which sit flush against each other may expand and contract, also, causing container breakage. Additionally, where moisture is present and containers are cooled, containers may freeze together making separation even more difficult. And finally, stacking can isolate significant portions of the containers from the atmosphere, thus slowing drying processes.

Generally speaking, the storage of beverage containers as well as their secure attachment to various objects has been the subject of a number of inventions. These inventions have had objectives such as properly securing a container to a car seat or other object or distribution of cooled containers. Other inventions include apparatuses which enclose a beverage container and help to regulate its temperature. However, there have been few, if any, inventions which relate to storing containers in a stacked formation in a manner which maintains separation between them. Despite this fact, stacking remains a common method of storing beverage containers.

### SUMMARY OF THE INVENTION

The apparatus and method disclosed herein involve the stacking of beverage containers. The apparatus, referred to herein as a device, has first and second receiving surfaces for receiving contact with containers, and has a structural member which separates them. The device is shaped and of such dimensions that when positioned along an outer surface of a first beverage container, portions of the device will be adjacent to the first container's outer surface thus forming the device's first receiving surface. From the first receiving surface extends a structural member toward a second receiving surface positioned adjacent to an inner surface or top of a second beverage container. The device serves to separate the sidewalls of the two containers. The method employs one such device between each container and the container stacked below or above it and may be employed to stack a number of consecutive containers upon each other.

### BRIEF DESCRIPTION OF THE DRAWINGS

FIG. 1 illustrates an embodiment of the method and of the device and depicts two stacked containers.

FIG. 2 illustrates a top view of an embodiment of the device including passages which allow for fluid communication between containers.

FIG. 3 illustrates a side view of an embodiment of the device.

FIG. 4 illustrates a top perspective of an embodiment of the device.

FIG. 5 illustrates a top perspective of another embodiment of the device employing a different configuration of passages.

FIG. 6 illustrates a top perspective of another embodiment of the device having a number of structural members between the receiving surfaces and a number of passages.

### DETAILED DESCRIPTION OF THE INVENTION

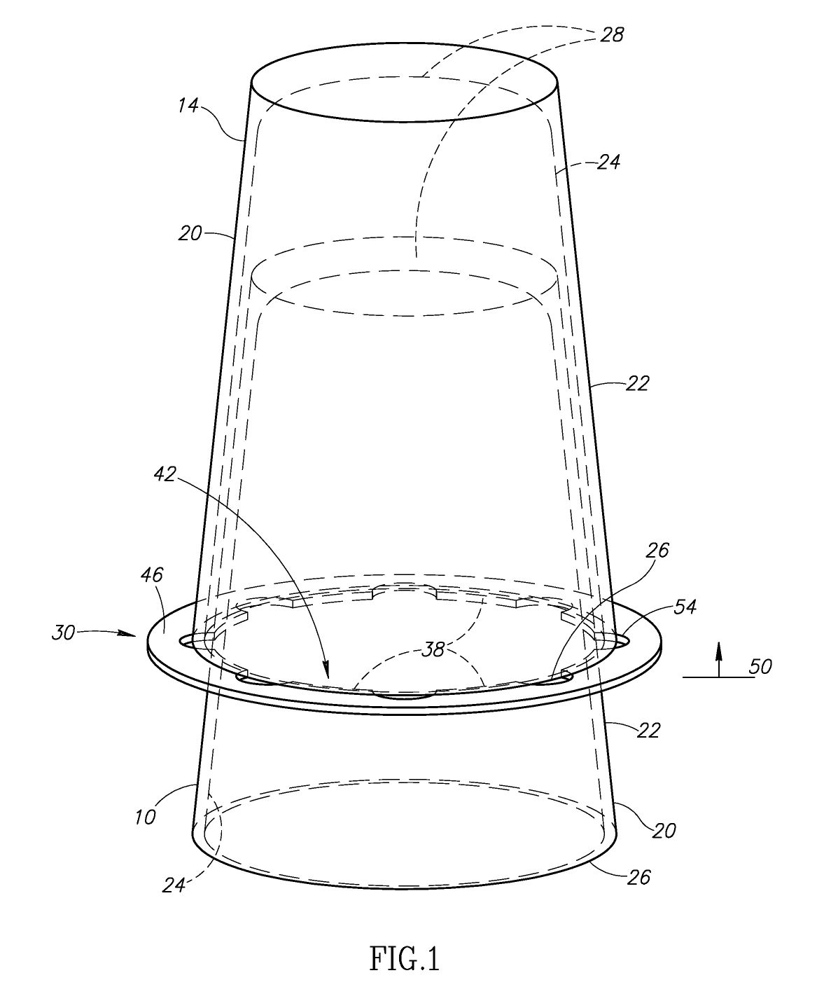

The present invention is adapted for use with multiple containers. However, the disclosure will refer to two exemplary containers depicted in FIG. 1. A first container 10 and a second container 14, each having sidewalls 20 with an outer surface 22 and an inner surface 24, as well a top 26 presenting an open end. The depicted containers are fluid-bearing and thus terminate in a closed end generally referred to herein as a bottom 28. The containers 10 and 14 are depicted in FIG. 1.

FIG. 1 shows an embodiment of the invention, a beverage container spacing device generally referred to by the reference numeral 30 in association with the first and second containers 10, 14. The device 30 includes a first receiving surface 38, a second receiving surface 42, and a structural member 46 extending between them. In addition, an axial plane 50 is generally oriented perpendicular to a central vertical axis extending between the stacked containers 10, 14.

The device 30 separates the inner surface 24 of the second container 14 from the outer surface 22 of the first container 10. Typically, one of the containers 10, 14 is supported by the device 30 in a vertical stack. Which container is referred to as “supported” depends upon whether the first 10 or second 14 container ends up “on top” in a vertical stack. However, horizontal or angular stacking may also be employed, thus it is not imperative that one of the containers 10, 14 be “supported” because the device is merely intended to maintain separation. Usage of the term “support” is intended merely as a guide in understanding the figures and the positioning of their elements and is not intended to limit the breadth of the claims.

It should also be noted that it is possible for portion(s) of the containers 10, 14 to directly contact each other without defeating the operation of the device 30. For example, in FIG. 1 the second container 14 could be positioned further to the left or right relative to the first container 10 such that one portion of the second container's 14 sidewall 20 is adjacent to the first container 10 and the opposing portion is separated further from the first container 10 than is depicted in FIG. 1. In this case, the device 30 would still create separation between the containers 10, 14.

In FIG. 1, the device 30 is depicted positioned around the outer surface 22 of the first container 10. The device's 30 first receiving surface 38, which forms the shape of a circle with an intermittent perimeter, has a sufficient diameter such that it is positioned near to the first container's 10 top 26, and is substantially parallel to the axial plane 50. The device 30 supports the second container 14 and contacts the second container 14 along the device's 30 upper, planar surface. The area of contact is the device's 30 second receiving surface 42. In this arrangement, the first container 10 is spaced from the second container 14. In addition to separating the containers 10, 14, the device 30 depicted in FIG. 1 allows for fluids like air and water to move along the inner surface 24 of the second container 14 and the outer surface 22 of the first container 10 via a series of passages 54 positioned near the outer surface 22 of the first container 10. Increasing fluid communication helps decrease the presence of fluid and its accumulation by exposing fluids which may exist on container 10, 14 surfaces to external conditions. Such fluids may be present due to condensation or washing processes, for example, and passages may provide for air movement, evaporation of fluids or drainage by gravitational forces.

Generally, the first receiving surface 38 is adjacent to the outer surface 22 of the first container 10. The second receiving surface 42 is adjacent to the second container 14, for example but not as a limitation, at the inner surface 24 or top 26. FIG. 1 also depicts support of the second container 14 along the top 26. The device 30 spaces the second container 14 from the first container 10 along the structural member 46 extending between the first and second receiving surfaces 38, 42. Generally speaking, the first container 10 sits partially inside of and is at least partially surrounded by the inner surface 24 of the second container 14.

In FIG. 1, the device 30 is positioned nearer the top 26 of the first container 10. In other embodiments, the diameter of the intermittent perimeter circle formed by the first receiving surface 38 may be smaller, thus the device 30 may be positioned nearer to the bottom 28 of the first container 10. Such an arrangement could provide for a greater degree of separation between the sidewalls 20 of the containers 10, 14.

The device 30 of FIG. 1 is also depicted with the second receiving surface 42 positioned adjacent to the top 26 of the second container 14. If the device 30 in FIG. 1 was of smaller outer diameter, it might present a second receiving surface 42 positioned adjacent to the inner surface 24 of the second container 14 rather than the top 26. In that case, increasing the outer diameter of the device 30 could also increase separation between the sidewalls 20 of the containers 10, 14.

FIG. 1 also illustrates a method consistent with the invention, including employing the device 30 to stack containers 10, 14. The method involves positioning the first receiving surface 38 adjacent to the outer surface 22 of the first container 10 and telescoping the second container 14 toward the first container 10 such that the second receiving surface 42 becomes engaged with the inner surface 24 or the top 26 of the second container 14. It is not imperative that the first receiving surface 38 be associated first with the first container 10—the second receiving surface 42 may be associated as a first step with the second container 14 without affecting the operability of the method. Telescoping, wherein the containers are oriented relative to each other and moved into sufficient proximity to facilitate the contact between the device 30 and the containers 10, 14, may be achieved regardless of which receiving surface 38, 42 makes contact first. It should also be noted that even though FIG. 1 shows a vertical stack of containers, the device 30 and method may be employed angularly or horizontally while still maintaining separation between container sidewalls 20.

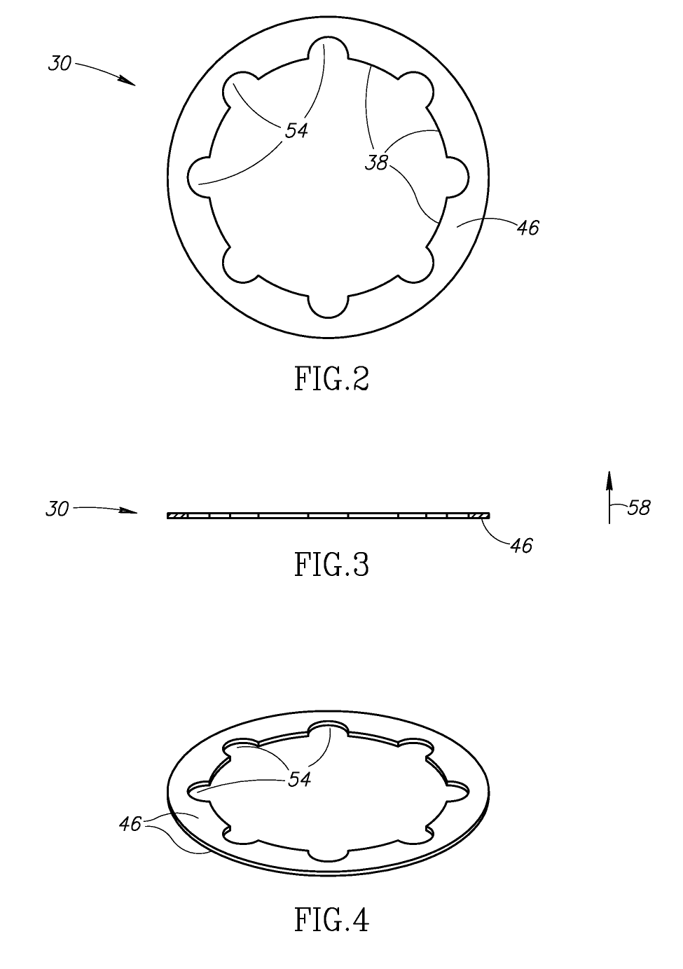

FIG. 2 shows a top view of the device 30 of FIG. 1. The first receiving surface 38 depicted in FIG. 2 forms the shape of a circle with an intermittent perimeter due to periodic breaks in contact with the outer surface 22 of the first container 10. These breaks form passages 54 which allow for fluids to move across the device 30, creating fluidic communication between the containers 10 and 14. However, the first receiving surface 38 may take a variety of shapes. The first receiving surface 38 need only be positioned against the outer surface 22 of the first container 10 such that the device 30 spaces the containers 10, 14 when stacked together. Similarly, the second receiving surface 42 may take any number of shapes so long as it is positioned adjacent to the second container 14 and helps space the stacked containers 10, 14.

For example, a similar top view of another embodiment of the device 30 could show a first receiving surface 38 forming the shape of an octagon with an incomplete perimeter. In operation with a frusto-conical glass, such an embodiment would have a segment lying in the middle of the length of each of the eight sides which would be tangential and adjacent to the outer surface 22 of the first container 10. These eight segments of contact would form the first receiving surface 38 of that embodiment and would be separated from the second receiving surface 42 by a structural member 46, whereby the containers 10, 14 would be spaced from each other. The remainder of each of these eight sides would be passages 54, just like the series of half-circles depicted in FIG. 2. In addition to the variety of device 30 shapes which may fit a particular first container 10, the device 30 may also take different shapes to adapt to the varying shapes the outer surface 22 of the first container 10 may take.

The device 30 may be comprised of one or more substantially rigid materials. Materials such as plastic, rubber, or steel or aluminum alloys are examples of materials which are capable of supporting the minimal pressure of separating the containers 10, 14 from one another. The material may also be solid or include hollow regions depending on the desired shape, characteristic and support necessary to function in separating the containers 10, 14.

FIG. 3 shows the representative embodiment of FIG. 2 from a side view. In addition to the components discussed above, it shows a length axis 58 defined in the opposite direction of the gravity force vector and the thickness of this device 30 is clearly depicted. The thickness may be adapted based upon the dimensions of the containers 10, 14 which are to be stacked and the desired degree of separation between them. The embodiment in FIG. 3 depicts a small thickness in relation to the axial dimensions of the device 30. This particular conformation will be discussed at greater length below. Of course, if it were desirable to create additional separation between containers 10, 14, one method by which to achieve that would be to increase the device's 30 thickness.

As mentioned above, the first receiving surface 38 shown in FIGS. 1-3, and most clearly from the top view in FIG. 2, forms a circular shape with an intermittent perimeter. The intermittent breaks in the first receiving surface 38 result from the passages 54. This may be common among the various embodiments of this disclosure, and may also occur in association with the second receiving surface 42 if passages 54 exist nearer that surface, and alternatively elsewhere along the device 30.

FIG. 4 shows the embodiment of FIGS. 1-3 from a top perspective. This perspective provides a better view of the passages 54 and the device's 30 outer perimeter. It also provides better perspective regarding the relative dimensions of the device 30.

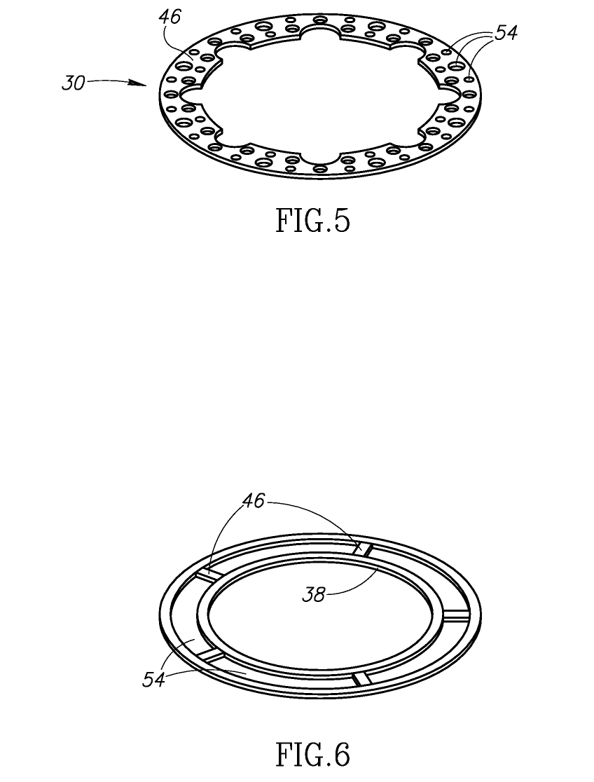

FIG. 5 depicts a different embodiment of the device 30 in which there are a number of passages 54 of different sizes. Passages 54 may vary in numerosity, dimension, and orientation. Indeed, the device 30 does not require these passages 54 at all to function as a spacing aid. However, these particular passages 54 are circular. Passages 54 in general do, optionally, help to increase the fluid communication across the device 30.

FIG. 6 depicts yet another embodiment of the device 30 having a second receiving surface 42 and a first receiving surface 38 separated by a number of structural members 46. The second receiving surface 42 may optionally form a circular shape with an intermittent perimeter if the device 30 is positioned adjacent to the top 26 of the second container 14. The second receiving surface 42 may also form a circular perimeter if it is positioned adjacent to the inner surface 24 of second container 14. Where the second receiving surface 42 lies on any particular embodiment, as mentioned above, depends on the adaptation of the device 30 to fit particular containers. Between the first and second receiving surfaces 38, 42 lie axially radiating structural members 46 which are made of substantially rigid materials capable of separating the stacked containers 10, 14. This embodiment also has passages 54 through which fluids may pass which may optionally aid in drying processes. The passages 54 depicted in FIG. 6 are elongated and arcuate in shape.

FIG. 6 also demonstrates another aspect of the disclosure in comparison with FIGS. 1-5. The structural member 46 may vary in form, dimension, and numerosity so long as it generally spaces the first receiving surface 38 from the second 42. In this embodiment, there are plural structural members 46 spaced radially around the first receiving surface 38 and extending outward toward the second receiving surface 42. In the previous Figures, the structural member 46 radially surrounded the first receiving surface 38 forming a disc-like shape. All are exemplary embodiments of the disclosure.

The present disclosure has described, and FIGS. 1-6 have depicted, several embodiments of the device 30 which achieve separation between stacked containers. Similarly, several optional embodiments of the disclosure include passages 54 through which fluids may pass. Finally, the disclosure includes a method by which the device 30 may be employed for stacking the containers 10, 14.

What is claimed is:

1. A beverage container spacing device for stacking plural beverage containers including a first and a second beverage container, each having a sidewall with an outer surface spaced from an inner surface, said device comprising:
a first receiving surface positioned along said outer surface of said first beverage container;
a second receiving surface positioned along said inner surface of said second beverage container; and,
a structural member extending between said first receiving surface towards said second receiving surface, whereby said sidewall of said first beverage container is spaced from said sidewall of said second beverage container.

2. The device according to claim 1, wherein said structural member extends radially from said first receiving surface towards said second receiving surface.

3. The device according to claim 1, wherein said structural member includes plural passages spaced along said structural member between said beverage containers.

4. The device according to claim 3, wherein said passages are circular.

5. The device according to claim 3, wherein said passages are elongated.

6. The device according to claim 1, wherein said structural member is substantially planar and said first and second receiving surfaces are radially spaced apart.

7. A beverage container spacing device for stacking plural beverage containers including a first and a second beverage container, each having a sidewall extending from a bottom towards a top, said device comprising:
a first receiving surface positioned along said sidewall of said first beverage container;
a second receiving surface associated with said top of said second beverage container; and,
a structural member extending between said sidewall of said first beverage container towards said top of said second beverage container, whereby said sidewall of said first beverage container is spaced from said sidewall of said second beverage container.

8. The device according to claim 7, wherein an arcuate passage is associated with said structural member whereby said first beverage container is in fluidic communication with said second beverage container.

9. The device according to claim 8, wherein said sidewall of said first container is further comprised of an outer surface and said sidewall of said second container is further comprised of an inner surface; wherein said inner surface is in fluidic communication with said outer surface.

10. A method for stacking plural beverage containers, including a first and a second beverage container, each having a sidewall with an outer surface spaced from an inner surface and wherein said sidewall terminates on its open end in a top, said method comprising:
placing a first receiving surface of a spacing device along said outer surface of said first beverage container;
telescoping said first beverage container towards said second beverage container; and,
engaging a second receiving surface of said spacing device with said second beverage container, whereby a structural member extends from said first beverage container toward said second beverage container and said sidewall of said first beverage container is spaced from said sidewall of said second beverage container.

11. The method of claim 10, further comprising the step of supporting at least one of said first and second beverage containers with said spacing device.
